(19) United States
(12) Patent Application Publication
(10) Pub. No.: US 2020/0117252 A1
(43) Pub. Date: Apr. 16, 2020

(54) COMPUTER SYSTEM AND METHOD OF OPERATING A COMPUTER SYSTEM

(71) Applicant: FUJITSU LIMITED, Kawasaki-shi (JP)

(72) Inventors: Sergej Beljaev, München (DE); Simon Czermak, München (DE)

(73) Assignee: FUJITSU LIMITED, Kawasaki-shi, (JP)

(21) Appl. No.: 16/591,824

(22) Filed: Oct. 3, 2019

(30) Foreign Application Priority Data
Oct. 15, 2018 (DE) 102018125501.2

(51) Int. Cl. G06F 1/20; G06F 1/28

(52) U.S. Cl. CPC G06F 1/20; G06F 2200/201; G06F 1/28

(57) ABSTRACT

A computer system that includes at least one fan and at least one power supply. The at least one power supply provides a main voltage in a first operating state of the computer system, and provides an auxiliary voltage in a second operating state of the computer system. The computer system also includes a first control device, which monitors power consumption of the system in the second operating state. The system includes at least one switching device which connects the at least one fan with the main voltage in the first operating state, and connects the at least one fan with the auxiliary voltage in the second operating state when the first control device registers a power consumption below a value, and disconnects the at least one fan from the auxiliary voltage in the second operating state when the first control device registers a power consumption above a value.

The present invention relates to a computer system comprising at least one fan and at least one power supply unit. The invention further relates to a method of operating such a computer system.

Computer systems frequently comprise at least one fan, for example at least one system fan, and at least one power supply unit via which, among other things, the at least one fan is supplied with current. Further, such computer systems are known that comprise a first operating state, for example a fully functional operating state, and a second operating state, for example a hibernation mode or soft-off mode. Numerous functions of the computer system are switched off in such a second operating mode, like, for example, the at least one fan as well.

An object of the present invention is to describe an alternative computer system and a method of operating the same.

In accordance with a first aspect, the above-mentioned object is achieved by a computer system comprising at least one fan and at least one power supply unit. The at least one power supply unit is configured to provide a main voltage in a first operating state of the computer system and to provide an auxiliary voltage in a second operating state of the computer system. The computer system moreover comprises a first control device, which is configured to monitor a power consumption of the computer system in the second operating state. Furthermore, the computer system further comprises at least one switching device, which is configured to connect the at least one fan with the main voltage in a first operating state, to connect the at least one fan with the auxiliary voltage in the second operating state, when the first control device registers a power consumption below a predetermined threshold value, and to disconnect the at least one fan from the auxiliary voltage in the second operating state, when the first control device registers a power consumption above a certain threshold value.

It is advantageous here that a cooling of the computer system or components arranged therein is possible by means of the at least one fan also in the second operating state, in which the at least one power supply unit provides an auxiliary voltage and no main voltage. In this way, it is possible to operate heat-generating components in the computer system, for example a network module, in the second operating state as well, without these components overheating.

In the first operating state, the at least one power supply unit provides, for example, the main voltage and the auxiliary voltage or the main voltage and no auxiliary voltage. In the second operating state, the at least one power supply unit provides the auxiliary voltage but no main voltage.

Moreover, it is advantageous here that, by means of the monitoring of the power consumption of the computer system in the second operating state and the at least one switching device, the risk is reduced that an impermissibly high current is drawn by the computer system via the at least one power supply unit in the second operating state. Since the power supply in such a computer system is usually limited to a comparatively low value in the second operating state relative to the first operating state, for example to 2 A, a too high power consumption of the computer system in the second operating state would lead to the breakdown of the voltage supply of computer system with the auxiliary voltage in the second operating state and/or the switching off of the at least one power supply unit in the second operating state. A switching from the second operating state back into the first operating state would then no longer be possible.

Moreover, in this way it is ensured that the at least one fan is disconnected from the auxiliary voltage in the second operating state when the power consumption of the computer system exceeds the predetermined threshold, in order to provide sufficient power for system-relevant elements, for example for a system monitoring. The system monitoring can thus, for example, record how the increase above the predetermined threshold of the power consumption of the computer system could have come about. Since such an increase can indicate a defect or a misconfiguration of the computer system, it is advantageous to make such information available to a user or any other monitoring unit.

In at least one configuration, the computer system further comprises a second control device which is configured to carry out a regulation of a rotary speed of the at least one fan by means of pulse width modulation, PWM.

In accordance with at least one configuration, the second control device is further configured to limit a duty cycle of the PWM control of the at least one fan, in the first operating state, to a first maximum value, and to limit the duty cycle to a second maximum value in the second operating state, wherein the first maximum value is greater than the second maximum value

Here, it is advantageous that a maximum power consumption of the at least one fan can be reduced by setting a reduced maximum duty cycle in the second operating state. For example, the first maximum value amounts to 100% and the second maximum value 50%. Alternatively, any other maximum values are, of course, also possible, however. For example, the second maximum value can, in this way, be adapted to a system configuration, that is, depending on how much power is drawn by other components in the second operating state. If PCIe cards are present in the computer system, for example, which cards are connected to the auxiliary voltage, the duty cycle of the PWM control can thus be limited to a lower second maximum value, in the second operating state, than in a computer system in which no such PCIe cards are installed.

According to a second aspect, the above-mentioned object is achieved by a method of operating a computer system according to the first aspect. The operating method includes the steps:
if the computer system is in a first operating state:
   connecting the at least one fan with the main voltage by means of the switching device; and
if the computer system is in a second operating state:
   connecting the at least one fan with the auxiliary voltage by means of the switching device;
   monitoring the power consumption of the computer system by means of the first control device; and
   disconnecting the at least one fan from the auxiliary voltage by means of the switching device if the power consumption exceeds a predetermined threshold value.

Configurations and advantages of the second aspect substantially correspond to the advantages and configurations of the first aspect. Further advantageous configurations are described in the appended claims as well as the subsequent description of exemplary embodiments based on the appended figures.

The figures show:

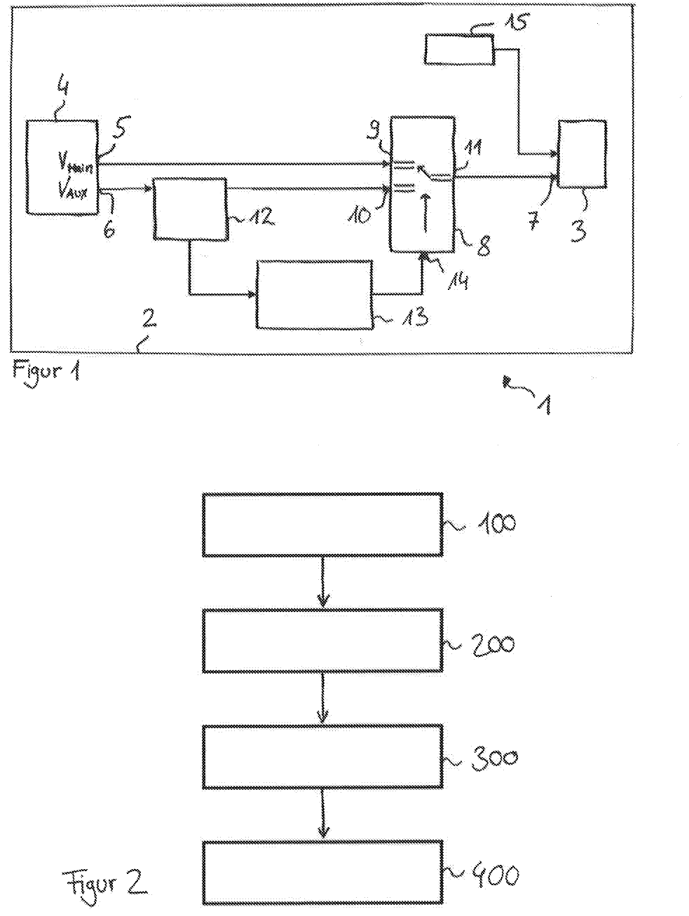

FIG. 1 a schematic representation of a computer system according to an exemplary embodiment of the invention, and

FIG. 2 a flow chart of an operating method for a computer system according to an exemplary embodiment of the invention.

FIG. 1 shows a schematic representation of a computer system 1 according to an exemplary embodiment of the invention. The computer system 1 comprises a casing 2, in which a fan 3 and a power supply unit 4 are arranged.

In this exemplary embodiment, the fan 3 is a system fan, which is arranged in the casing 2 such that it cools various heat-generating elements, for example a network module and/or add-on and memory cards, when it is active. Alternatively, the fan 3 can, of course, however also relate to any other fan, for example a fan which cools primarily only one particular heat-generating component, for example only the network module, in the computer system 1.

In this exemplary embodiment, the power supply unit 4 relates to a switching power supply with a first switching converter and a second switching converter. The first switching converter is configured to provide a main voltage Vₘₐᵢₙ, of 12 V for example, at a first output 5 of the power supply unit 4, in a first operating state of the computer system 1. The second switching converter is configured to provide an auxiliary voltage Vₐᵤₓ, likewise of 12 V for example, at a second output 6 of the power supply unit 4, in a second operating state of the computer system 1. In place of the second switching converter, the power supply unit 4 can also comprise a linear regulator. Other configurations of the power supply unit 4 are, of course, likewise possible.

The first operating state of the computer system is a fully functional operating state of the computer system, in this exemplary embodiment, an S0 state according to the Advanced Configuration and Power Interface, ACPI, standard. The second operating state of the computer system represents a hibernation mode or a soft-off-state of the computer system, in this exemplary embodiment, an S4 or S5 state according to the ACPI standard. In this exemplary embodiment, the power supply unit 4 provides the auxiliary voltage Vₐᵤₓ in the first, as well as in the second operating state of the computer system 1. The main voltage Vₘₐᵢₙ is only provided by the power supply unit 4 in the first operating state of the computer system 1, however. In the second operating state, the main voltage Vₘₐᵢₙ is switched off. A maximum provided power of the second switching converter, which provides the auxiliary voltage Vₐᵤₓ, is limited to a substantially lower value relative to a power provided by the first switching converter. In this exemplary embodiment, a power which, in the second operating state, is provided via the second output 6 of the power supply unit 4 is limited to a value of 24 W, that is, a current of 2 A can maximally be drawn via the second output 6.

The fan 3 comprises a connection 7, via which the fan 3 is supplied with a voltage. The voltage which is applied to the connection 7 of the fan 3 is provided by the power supply unit 4. A switching device 8 is interposed between the fan 3 and the power supply unit 4. The switching device 8 is a discrete circuit, in this case composed of field-effect transistors, FETs.

The switching device 8 comprises a first input 9, a second input 10 and an output 11. The output 11 is electrically connected with the connection 7 of the fan 3. The first input 9 is electrically connected with the first output 5 of the power supply unit 4, and the second input 10 of the switching device 8 is electrically connected with the second output 6 of the power supply unit 4. Depending in which switching state the switching device 8 finds itself, the first input 9 or the second input 10 is connected through to the output 11. In this way, either the main voltage Vₘₐᵢₙ or the auxiliary voltage Vₐᵤₓ is applied to the connection 7 of the fan 3, depending on the switching state of the switching device 8.

In this exemplary embodiment, an amperemeter 12 is interposed between the second output 6 of the power supply unit 4 and the second input 10 of the switching device 8. The amperemeter 12 measures a current drawn via the second output 6 of the power supply unit 4. In other words, it is possible to monitor a power of the computer system 1 taken up in the second operating state by means of the amperemeter 12

The information detected by the amperemeter 12 is passed on to a control module 13. The control module 13 is a microcontroller in this exemplary embodiment, which can communicate with a Baseboard Management Controller, BMC, or an Integrated Remote Management Controller, iRMC, of the computer system 1. The control module 13 monitors the operating state of the computer system 1, that is, whether the computer system 1 is in the first operating state or the second operating state. This information is communicated to the control module 13, for example by the BMC or iRMC.

The control module 13 further monitors if the current measured by the amperemeter 12 lies above or below a predetermined threshold value. This predetermined threshold value depends on a maximum power specific to the power supply unit 4, which power is provided in the second operating state of the computer system. In the present exemplary embodiment, this maximum power amounts, for example, to 24 W in the second operating state. In this case, the control module 13 monitors if the current drawn via the second output 6 of the power supply unit 4 exceeds a threshold value of 2 A. Based on this monitoring, the control module 13 generates a control signal, which is applied to a control input 14 of the switching device 8. With this control signal, the switching state of the switching device 8 is switched. In this exemplary embodiment, the switching signal relates to a GPIO signal.

In the subsequent scenarios, the switching device 8 is switched, by means of the control signal generated by the control module 13, as follows:

If the computer system 1 is in the first operating state, that is, in the S0 ACPI state, the first input 9 of the switching device is connected through to the output 11. In this case, the fan 3 is supplied with the main voltage Vₘₐᵢₙ.

If the computer system 1 is switched to the second operating state, that is, the S4 or S5 ACPI state, the control module 13 signals the switching device 8 that the second input 10 should be connected through to the output 10. Thereafter, the fan 3 is connected with the auxiliary voltage Vₐᵤₓ by the switching device 8.

If a rise of the current received via the second output 6 of the power supply unit 4 above the threshold value of 2 A is detected in the second operating state by the amperemeter 12, the control module 13 signals the switching device 8 so that the switching device 8 is to connected to the first input 9 through to the output 11 again. Due to the fact that the main voltage Vₘₐᵢₙ is turned-off in this second operating state, the fan 3 is not supplied with voltage in this way, that is the fan 3 is switched-off.

By switching-off the fan 3 upon a rise of power consumption above the threshold value in the second operating state, the risk that the auxiliary voltage Vₐᵤₓ is turned-off due to too high a power consumption of the computer system 1 in the second operating state, is reduced. A switching-off of the auxiliary voltage Vₐᵤₓ would mean that the computer system 1 can not be booted any more. Moreover, a safe supply of voltage of other components of the computer system, e.g. system monitoring devices, is ensured. The switching-off of the fan 3 can result in that e.g. components that are cooled by the fan 3 in the second operating state, such as a network module in the present exemplary embodiment, overheat and turn-off. However, the functionality of system-relevant components such as a system monitoring device is ensured, and a recording of such an overheating and turning-off of the network module is possible, in order to be able to communicate this fact to a user.

Furthermore, the fan 3 is connected with a fan control 15 which controls a rotary speed of the fan by means of pulse width modulation, PWM. The fan control 15 is implemented in a BMC or iRMC, for example. In this exemplary embodiment, the fan control 15 comprises firmware by means of which a maximum duty cycle of the PWM control can be limited. For example, the firmware allows a maximum duty cycle of the PWM control of 100% if the main voltage Vₘₐᵢₙ is turned-on, that is the computer system 1 is in the first operating state. For example, the firmware limits the maximum duty cycle of the PWM control to 50% if the main voltage Vₘₐᵢₙ is turned-off, that is the computer system 1 is in the second operating state. In this way, a lower maximum speed of the fan 3 is permitted in the second operating state compared to the first operating state, and thus a maximum power consumption of the fan 3 is reduced in the second operating state of the computer system 1. The maximum duty cycle of the PWM control for the second operating state can, in particular, be adapted to a system configuration. If multiple components are installed in the computer system 1 that receive power via the second output 6 of the power supply unit 4 in the second operating state, the maximum possible duty cycle is reduced more, for example to only 30% compared with a situation where less or no such components are installed or active in the computer system 1.

FIG. 2 shows a flow chart for a method of operating a computer system according to an exemplary embodiment of the invention. The operating method in accordance with FIG. 2 can be used for the computer system 1 of FIG. 1, for example.

The computer system 1 initially is in a first operating state, e.g. in the S0 state according to the ACPI standard. A fan of the computer system that cools a network module, for example, is supplied with a main voltage Vₘₐᵢₙ provided by a power supply unit in this first operating state.

In a first step 100, a control module of the computer system monitors whether the computer system is put to a second operating state, for example the S4 or S5 state according to the ACPI standard. This monitoring occurs continuously or repeatedly while the computer system is in the first operating state.

If, in the first step 100, a switching of the computer system to one of the states S4 or S5 is detected, in a second step 200, the voltage supply of the fan is switched, by means of a switching device, to an auxiliary voltage Vₐᵤₓ provided by the power supply unit of the computer system.

In the case that the fan of the computer system is connected with the auxiliary voltage Vₐᵤₓ, in a third step 300, a control device monitors a power consumption of the computer system in the S4 or S5 states. This monitoring occurs continuously or repeatedly while the computer system is in the second operating state. In addition, it is possible to reduce a maximum possible duty cycle of a PWM control of the fan compared to the first operating state, in the third step 300.

In the case that the power consumption of the computer system exceeds a predetermined threshold value, in a fourth step 400, the fan is disconnected from the auxiliary voltage by means of the switching device. In this way, the fan is turned-off and a power consumption of the computer system is reduced.

### LIST OF REFERENCE CHARACTERS

1 Computer system
2 casing
3 fan
4 power supply unit
5 first output of the power supply unit
6 second output of the power supply unit
7 connection of the fan
8 switching device
9 first input of the switching device
10 second input of the switching device
11 output of the switching device
12 amperemeter
13 control module
14 control input
15 fan control
Vₘₐᵢₙ main voltage
Vₐᵤₓ auxiliary voltage
100-400 method steps

1. A computer system, comprising
at least one fan,
at least one power supply unit, configured to provide a main voltage in a first operating state of the computer system, and to provide an auxiliary voltage in a second operating state of the computer system,
a first control device, configured to monitor a power consumption of the computer system in the second operating state, and
at least one switching device, configured to connect the at least one fan with the main voltage in the first operating state, to connect the at least one fan with the auxiliary voltage in the second operating state when the first control device registers a power consumption below a predetermined threshold, and to disconnect the at least one fan from the auxiliary voltage in the second operating state when the first control device registers a power consumption above a predetermined threshold.

2. The computer system according to claim 1,
wherein the first control device includes an amperemeter to monitor the power consumption of the computer system, wherein the amperemeter is configured to measure a current provided by the power supply unit in the second operating state.

3. The computer system according to claim 1, wherein the first operating state of the computer system represents a fully-functional operating state of the computer system, in particular an S0-state according to the Advanced Configuration and Power Interface, ACPI, standard, and the second operating state of the computer system represents a hibernation state or soft-off-state of the computer system, in particular an S4 or S5 state in accordance with the ACPI standard.

4. The computer system according to claim 1, further comprising a second control device which is configured to carry out a regulation of a rotary speed of the at least one fan by means of pulse width modulation, PWM.

5. The computer system according to claim 4,
wherein the second control device is further configured to limit a duty cycle of the PWM-control of the at least one fan to a first maximum value in the first operating state, and to limit the duty cycle to a second maximum value in the second operating state, wherein the first maximum value is greater than the second maximum value.

6. The computer system according to claim 4, wherein the first control device is a microcontroller, and the second control device is implemented in a Baseboard Management Controller, BMC, or in an Integrated Remote Management Controller, IRMC.

7. The computer system according to claim 1, wherein the at least one fan is at least one system fan.

8. A method of operating a computer system including at least one fan, at least one power supply unit configured to provide a main voltage in a first operating state of the computer system and to provide an auxiliary voltage in a second operating state of the computer system, a first control device configured to monitor a power consumption of the computer system in the second operating state, and at least one switching device configured to connect the at least one fan with the main voltage in the first operating state, to connect the at least one fan with the auxiliary voltage in the second operating state when the first control device registers a power consumption below a predetermined threshold, and to disconnect the at least one fan from the auxiliary voltage in the second operating state when the first control device registers a power consumption above a predetermined threshold, the method comprising:
if the computer system is in the first operating state:
connecting the at least one fan with the main voltage by means of the switching device; and
if the computer system is in the second operating state:
connecting the at least one fan with the auxiliary voltage by means of the switching device;
monitoring the power consumption of the computer system by means of the first control device; and
disconnecting the at least one fan from the auxiliary voltage by means of the switching device if the power consumption exceeds a predetermined threshold value.

9. The operating method according to claim 8, wherein the computer system further comprises a second control device for the regulation of a rotary speed of the at least one fan by means of pulse width modulation, PWM, the operating method further comprising:
limiting a duty cycle of the PWM control of the at least one fan, in the first operating state, to a first maximum value by means of the second control device; and
limiting the duty cycle, in the second operating state, to a second maximum value by means of the second control device,
wherein the first maximum value is greater than the second maximum value.
